(19) United States
(12) Patent Application Publication
(10) Pub. No.: US 2019/0149989 A1
(43) Pub. Date: May 16, 2019

(54) WIRELESS RELAY DEVICE AND SETTING METHOD

(71) Applicant: YAMAHA CORPORATION, Hamamatsu-shi (JP)

(72) Inventors: Tadahiko MORIYA, Hamamatsu-shi (JP); Hirokazu SUZUKI, Hamamatsu-shi (JP); Kenji ISHIHARA, Hamamatsu-shi (JP)

(21) Appl. No.: 16/244,247

(22) Filed: Jan. 10, 2019

Related U.S. Application Data
(63) Continuation of application No. PCT/JP2016/070517, filed on Jul. 12, 2016.

(51) Int. Cl. H04W 12/06; H04B 7/14; H04W 48/08; G06F 16/11

(52) U.S. Cl. CPC H04W 12/06; H04B 7/14; H04W 84/12; G06F 16/116; H04W 48/08

(57) ABSTRACT

A setting method performed by a wireless relay device includes: receiving a setting file in a first format for defining a setting content relating to a wireless network, the setting file defining a plurality of types of data including identification information of a wireless terminal to correspond to each of a plurality of users; separating the plurality of types of data from the setting file to extract individual data for each of the plurality of users; and setting a wireless network for each of the plurality of users based on the individual data for the user.

### CROSS-REFERENCE TO RELATED APPLICATIONS

This application is a U.S. continuation application filed under 35 U.S.C. § 111(a), of International Application No. PCT/JP2016/070517, filed on Jul. 12, 2016, the disclosures of which are incorporated by reference.

### FIELD

The present invention relates to a communication relay device.

### BACKGROUND

Conventionally, there has been a technique for reading a template in which names of initial setting items and attributes of each of the items are defined into a network management server for each of types of network terminals and automatically registering a MAC (Media Access Control) address and an initial setting value of each of the network terminals. Accordingly, work by a network manager can be reduced. The technique is disclosed in Japanese Patent Application Laid-Open No. 2005-50302.

### SUMMARY

According to an aspect of the present invention, there is provided a wireless relay device including a processor configured to execute instructions of: receiving a setting file in a first format for defining a setting content relating to a wireless network, the setting file defining a plurality of types of data including identification information of a wireless terminal to correspond to each of a plurality of users; separating the plurality of types of data from the setting file to extract individual data for each of the plurality of users; and setting a wireless network for each of the plurality of users based on the individual data for the user.

### BRIEF DESCRIPTION OF THE DRAWINGS

FIG. 1 is a conceptual diagram for describing a situation where user information is loaded into a wireless relay device according to a first embodiment of the present invention;

FIG. 2 is a block diagram illustrating a configuration of the wireless relay device according to the first embodiment of the present invention;

FIG. 3 is a block diagram illustrating functional blocks in a control unit in the wireless relay device according to the first embodiment of the present invention;

FIG. 4A is a flowchart illustrating an example of an operation of the wireless relay device according to the first embodiment of the present invention;

FIG. 4B is a flowchart illustrating an example of an operation of a wireless relay device according to another example of the first embodiment of the present invention;

FIG. 5 is a conceptual diagram for describing a situation where the wireless relay device according to the first embodiment of the present invention sets a wireless network and an authentication for a user;

FIG. 6 is a conceptual diagram illustrating that the wireless relay device according to the first embodiment of the present invention transmits data to other wireless relay devices;

FIG. 7 is a block diagram illustrating a configuration of a wireless relay device according to a modification to the present invention; and

FIG. 8 is a block diagram illustrating a configuration of a wireless relay device according to a modification to the present invention.

### DESCRIPTION OF EMBODIMENTS

One embodiment of the present invention will be described in detail below with reference to the drawings. Embodiments described below are examples of the embodiment of the present invention, and the present invention is not limited to the embodiments. In the drawings referred to in the present embodiment, identical units or units having similar functions are respectively assigned identical or similar reference symbols (reference numbers followed by A, B, etc.), and repetitive description may be omitted. A dimensional ratio in the drawings may differ from an actual ratio for convenience of illustration, or some of components may be omitted from the drawings.

A technique disclosed in Japanese Patent Application Laid-Open No. 2005-50302, a network itself is not set. In a network requiring an authentication for connection, setting for authentication connection to a terminal needs to be separately performed, which is troublesome.

A communication relay device according to the one embodiment described below enables access control of a communication terminal to a network to be more simply performed.

### First Embodiment

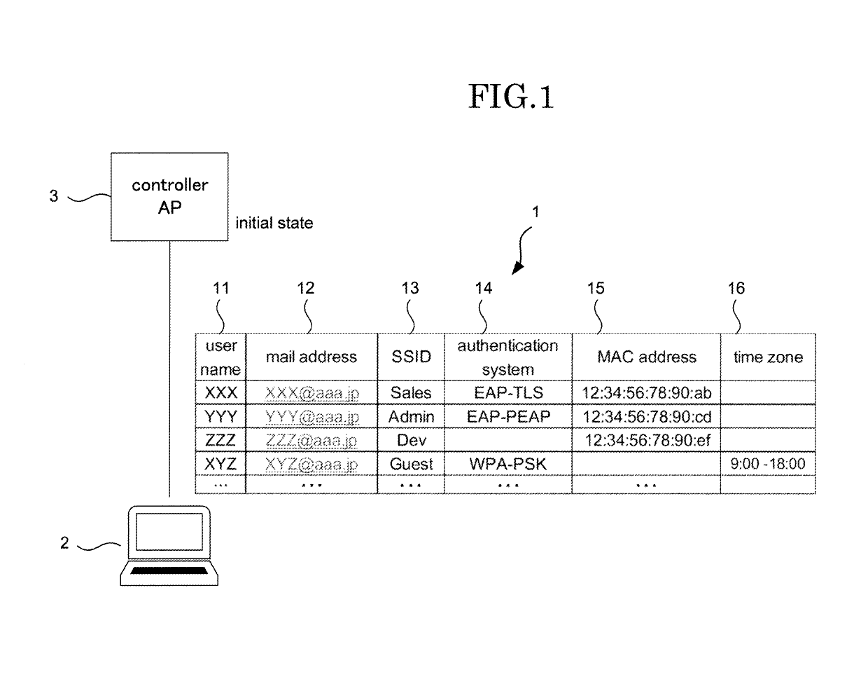

A situation where user information is loaded into a wireless relay device 3 will be described with reference to FIG. 1. FIG. 1 is a conceptual diagram for describing the situation where the user information is loaded into the wireless relay device 3 according to a first embodiment of the present invention.

In this example, a user information setting file 1 is loaded into the wireless relay device 3 from a manager terminal 2. More specifically, a manager generates the user information setting file 1 at the manager terminal 2. When the user information setting file 1 is stored in a storage device in the manager terminal 2. When the user information setting file 1 is transmitted to the wireless relay device 3 from the manager terminal 2, the user information setting file 1 is loaded into the wireless relay device 3. In this example, the wireless relay device 3 is a wireless access point.

The user information setting file 1 is a file in a tabular form, as illustrated in

FIG. 1. The user information setting file 1 is a file in a format described in a natural language. The user information setting file 1 may be a file in another format if it can be inputted by a user.

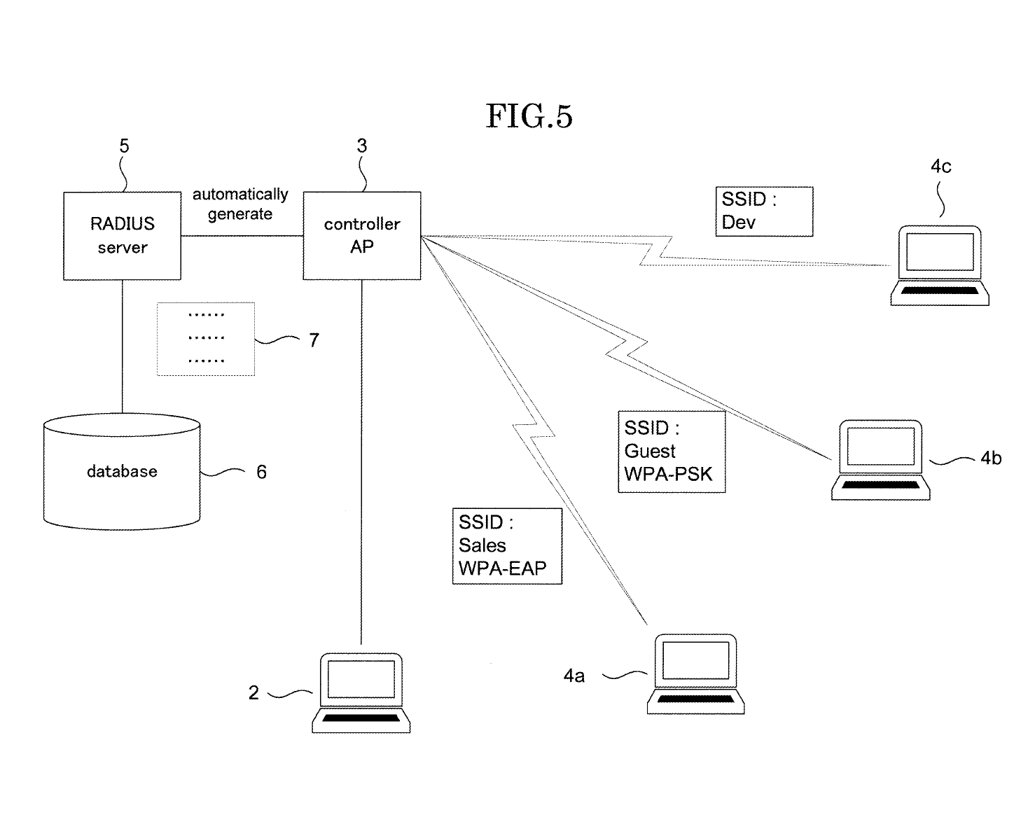

The user information setting file 1 includes a user name column 11, a mail address column 12, an SSID (Service Set Identifier) column 13, an authentication system column 14, a MAC address column 15, and a time zone column 16 in this example. The user information setting file 1 may be provided with a user expiration date column and a comment column for storing a note. Although the authentication system column 14 is provided in this example, the authentication system column 14 need not be provided. A user name (user ID (identification)) is inputted to the user name column 11. The user name is information for specifying, when wireless terminals 4a, 4b, and 4c (see FIG. 5) connect to the wireless relay device 3 for communication, a user who uses each of the wireless terminals. The wireless terminals 4a, 4b, and 4c are referred to as a “wireless terminal 4” if they need not be particularly distinguished.

Data respectively inputted to the mail address column 12, the SSID column 13, the authentication system column 14, the MAC address column 15, and the time zone column 16 in the same row as a row including the user name inputted to the user name column 11 are data associated with the user. In this example, a plurality of user names are inputted to the user name column 11. When the plurality of user names are inputted, respective wireless networks and authentications can be set collectively for a plurality of users.

A mail address corresponding to a user name is inputted to the mail address column 12. If there is a user name, a user who uses the wireless terminal 4 can be specified. Accordingly, a mail address is not essential. When the mail address is inputted, the mail address can be used as a destination of an electronic certificate or the like, described below.

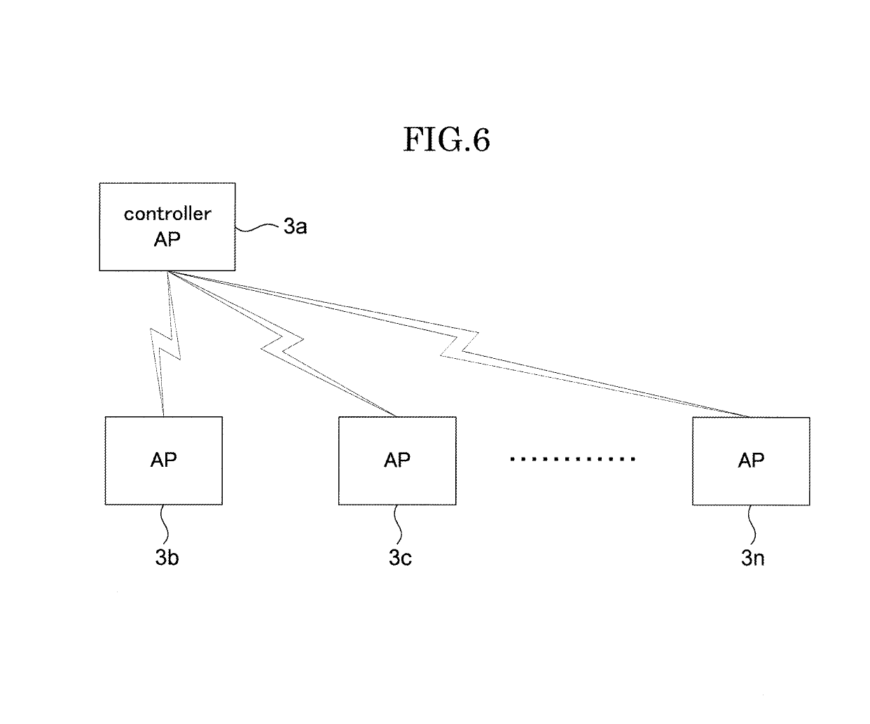

An ESSID (Extended Service Set Identifier) is inputted to the SSID column 13. In this example, “Sales” representing a sales department, “Admin” representing a general affairs department, “Dev” representing a development department, and “Guest” representing a guest user are inputted. In this example, wireless relay devices 3b, 3c, etc. (see FIG. 6) are each a VAP (Virtual Access Point). If the wireless relay devices 3b, 3c, etc. are each a VAP, a plurality of ESSIDs (a Multi ESSID) can be set. The wireless relay devices 3b, 3c, etc. need not be each a VAP. In the wireless relay devices, different ESSIDs may be respectively set.

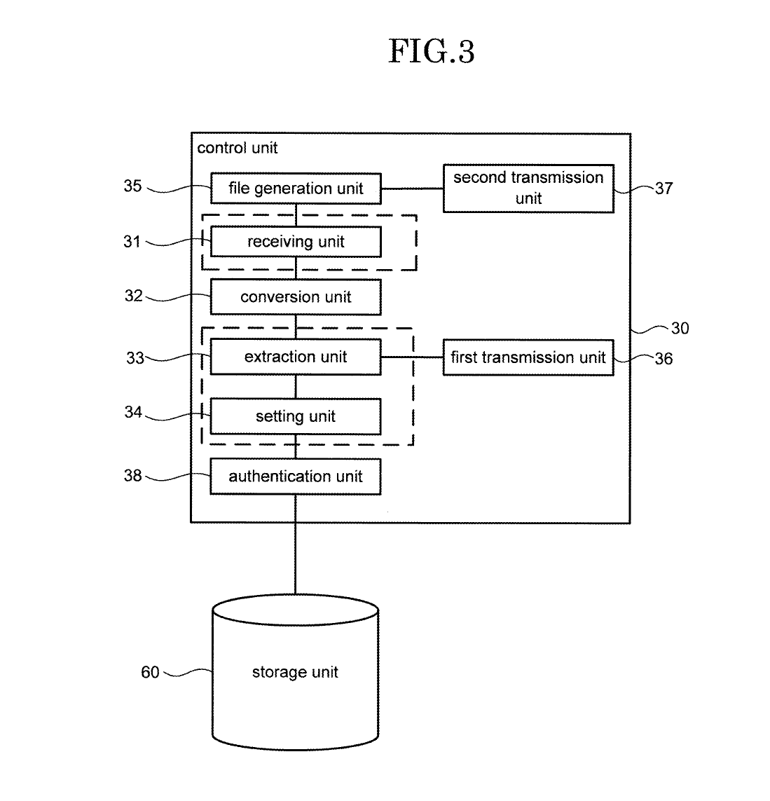

Information about an authentication system is inputted to the authentication system column 14. In this example, in the authentication system column 14 corresponding to a user name “XXX”, “EAP-TLS” is described. This indicates that EAP (Extensible Authentication Protocol)-TLS (Transport Layer Security) as a certificate system is used for an authentication. If the system is used, a password is used to protect a client certificate and a secret key. An EAP is one of authentication systems used in IEEE (Institute of Electrical and Electronic Engineers) 802.1X. In an IEEE 802.1X authentication, a user who has connected to an access point is authenticated by a RADIUS (Remote Authentication Dial In User Service) server, to determine whether or not access is permitted. The RADIUS server may be contained in the wireless relay device 3 as an authentication unit 38 (see FIG. 3), like in the present embodiment. The RADIUS server may be separately provided outside the wireless relay device 3.

In the authentication system column 14 corresponding to a user name “YYY”, “EAP-PEAP (Protected Extensible Authentication Protocol)” is described. This indicates that EAP-PEAP as a password system is used for an authentication. Examples of a value actually inputted include a user ID and a password to be inputted by a user who uses the wireless terminal 4. In the authentication system column 14 corresponding to a user name “XYZ”, “WPA-PSK” is described. This indicates that WPA-PSK (Wi-Fi Protected Access Pre-Shared Key) is used for an authentication. In the authentication system column 14 corresponding to a user name “ZZZ”, nothing is inputted. This indicates that a user can connect to an access point without any authentication. Not only the foregoing examples but also other EAP systems such as EAP-TTLS (Tunneled Transport Layer Security), EAP-FAST (Flexible Authentication via Security Tunneling), and EAP-MD5 (Message Digest 5) or a WPA2-PSK (Wi-Fi Protected Access2 PSK (Pre-Shared Key)) system, for example, may be used by being inputted to the authentication system column 14.

A MAC address is inputted to the MAC address column 15. A MAC address “12:34:56:78:90:ef” is inputted to a MAC address corresponding to the user name “ZZZ”. The user name “ZZZ” is authenticated by the wireless terminal 4 having the registered MAC address “12:34:56:78:90:ef”. This corresponds to so-called MAC address filtering. On the other hand, in the MAC address column 15 corresponding to the user name “XYZ”, nothing is inputted. This indicates that a user can connect to an access point regardless of a MAC address if there are a user name and a password.

Information about a time zone in which a user can connect to an access point is inputted to the time zone column 16. In the time zone column 16 corresponding to the user name “XXX”, nothing is inputted. This indicates that a user can connect to an access point in any time zone. On the other hand, in the time zone column 16 corresponding to the user name “XYZ”, “9:00-18:00” is inputted. This indicates that the wireless terminal 4b used by the user name “XYZ” can connect to an access point in a time zone from 9:00 to 18:00.

The wireless relay device 3 is an access point (AP) of a wireless LAN (local area network) in this example. Although the wireless relay device 3 controls the other wireless relay devices 3b, 3c, etc. in this example, the wireless relay device 3 is the same as the other wireless relay devices 3b, 3c, etc. as equipment. The wireless relay device 3 may be referred to as a controller access point (controller AP) because it has a function of controlling the other wireless relay devices 3b, 3c, etc. On the other hand, the other wireless relay devices 3b, 3c, etc. controlled by the controller access point may be each referred to as a member access point.

The manager terminal 2 is connected to the wireless relay device 3 by wire in this example. A manager applies the user information setting file 1 to the wireless relay device 3 from the manager terminal 2, and loads the user information setting file 1 into the wireless relay device 3 in an initial state.

### [Configuration of Wireless Relay Device]

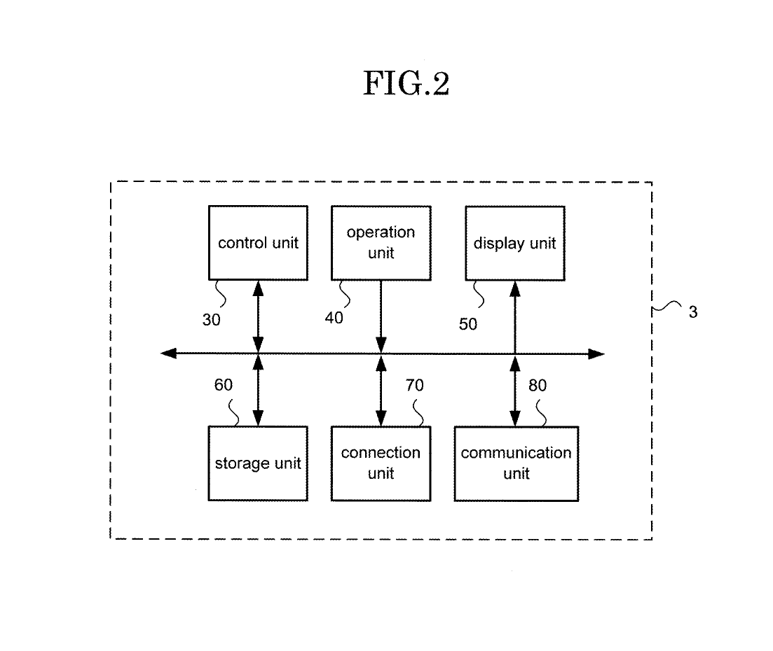

A configuration of the wireless relay device 3 will be described below with reference to FIG. 2. FIG. 2 is a block diagram illustrating a configuration of the wireless relay device 3 according to the first embodiment of the present invention.

The wireless relay device 3 includes a control unit 30, a storage unit 60, an operation unit 40, a display unit 50, a connection unit 70, and a communication unit 80. The components are connected to one another via a bus.

The control unit 30 includes an arithmetic processing circuit (processor) such as a CPU (central processing unit). The control unit 30 causes the CPU (a computer) to execute a program stored in the storage unit 60 to implement a function for performing setting processing based on instructions included in the program, described below. Some or all of components implementing the function may be not only implemented by software by executing the program but also implemented by hardware. The function implemented by the control unit 30 includes a function of controlling each of the units in the wireless relay device 3 in addition to the function for performing the setting processing (a setting function).

The storage unit 60 is a storage device such as a nonvolatile memory or a hard disk. The storage unit 60 includes a storage area storing an application program for implementing various functions such as the above-described program and a storage area storing setting information set by setting processing or the like. The program may be executable by a computer, and may be provided while being stored in a computer readable recording medium such as a magnetic recording medium, an optical recording medium, a magneto-optical recording medium, or a semiconductor memory. In this case, the wireless relay device 3 may include a device which reads the recording medium. The program may be downloaded via a network.

The operation unit 40 outputs a signal corresponding to an operation inputted by the user using an operation button or the like to the control unit 30. An example of the operation button may be an operator which includes a power switch, a cursor key, and the like and receives an instruction from the user. The display unit 50 is a display device such as a liquid crystal display or an organic EL (electro-luminescence) display and displays a screen (a setting screen, etc.) based on the control by the control unit 30. The wireless relay device 3 may not include the operation unit 40 and the display unit 50. In this case, the operation unit 40 and the display unit 50 may be respectively replaced with functions corresponding to the operation unit 40 and the display unit 50 in an external device connected to the wireless relay device 3.

The connection unit 70 is an interface to be connected to the above-described manager terminal 2. In this example, the connection unit 70 and the manager terminal 2 are connected to each other by wire.

The communication unit 80 is connected to a network (not illustrated) based on the control by the control unit 30, to transmit information from the external device or to receive information from the external device. The wireless relay device 3 has been described above.

A configuration of the control unit 30 in the wireless relay device 3 will be described below with reference to FIG. 3. FIG. 3 is a block diagram illustrating functional blocks in the control unit 30 in the wireless relay device 3 according to the first embodiment of the present invention. The storage unit 60 is also illustrated for convenience of illustration in FIG. 3.

The control unit 30 in the wireless relay device 3 includes a receiving unit 31, a conversion unit 32, an extraction unit 33, a setting unit 34, a file generation unit 35, a first transmission unit 36, a second transmission unit 37, and an authentication unit 38. The function for performing setting processing is implemented by these units.

The receiving unit 31 receives a setting file in a first format for defining a setting content relating to a wireless network. The setting file defines a plurality of types of data including information about identification information of the wireless terminal 4 to correspond to each of a plurality of users. The setting file may be a file for further defining a setting content relating to an authentication. The setting file includes a plurality of types of data such as information about the identification information of the wireless terminal 4. The plurality of types of data may further include information about an authentication system. Therefore, the receiving unit 31 may receive the setting file in the first format for defining the respective setting contents relating to a wireless network and an authentication, like in this example. The setting file may define the plurality of types of data including the identification information of the wireless terminal 4 and the information about an authentication system to correspond to each of the plurality of users. In this example, the identification information of the wireless terminal 4 is a MAC address. The information about an authentication system is information representing an EAP or a PSK. In the case of the PSK, a password is inputted. The plurality of types of data may include a user name, a mail address, an SSID, and time zone information, as described above. The first format is a format described in a natural language in this example. Examples of the first format include a CSV (Comma Separated Values) format, an XML (Extensible Markup Language), an HTML (HyperText Markup Language), and an application specific format of spreadsheet software. The first format is not limited to the formats if it can represent a tabular form. The receiving unit 31 receives data via the communication unit 80.

The conversion unit 32 converts the setting file in the first format into a setting file in a second format. In this example, the conversion unit 32 converts the CSV format (first format) into a Configuration File (environment setting file) in the second format. The first format may be converted into an intermediate format before being converted into the second format. If mounting of a conversion function into the Configuration File accepts only the CSV format, for example, the XML may be converted into the Configuration File after being converted into the CSV format once to implement conversion from the XML to the Configuration File. When the intermediate format is used, the number of types of formats usable as the first format can be increased.

The extraction unit 33 separates the plurality of types of data from the setting file to extract individual data for each of the plurality of users.

The setting unit 34 sets a wireless network for each of the plurality of users based on the individual data for the user extracted by the extraction unit 33. If the receiving unit 31 receives the setting file defined as described above, the setting unit 34 may further set an authentication for each of the plurality of users based on the extracted individual data for the user. The setting file defined as described above is a file for defining the plurality of types of data including the identification information of the wireless terminal 4 and the information about an authentication system to correspond to each of the plurality of users using the first format for defining the respective setting contents relating to a wireless network and an authentication. Setting a wireless network is providing the identification information of the wireless terminal 4 for the wireless terminal 4 to connect to the wireless network via the wireless relay device 3. Setting an authentication is providing an authentication system required of the wireless terminal 4 for the wireless terminal 4 to connect to the wireless network via the wireless relay device 3. The SSID and the authentication system are respectively set as “Sales” and “EAP-TLS” for the user name “XXX”, for example, as illustrated in the user information setting file 1. In this example, user information inputted to the user information setting file 1 is held in an external database. In the case of EAP-TLS, a RADIUS server is used. However, in this example, the RADIUS server is contained in the wireless relay device 3 as the authentication unit 38, as described below. On the other hand, if the RADIUS server is provided outside the wireless relay device 3, user information may be held in a local database by the RADIUS server or may be held in the external database.

The first transmission unit 36 transmits the individual data for each of the plurality of users extracted by the extraction unit 33 to the other wireless relay devices 3b, 3c, etc. to be linked with the wireless relay device 3a. Details will be described in description of FIG. 6. The first transmission unit 36 transmits data via the communication unit 80.

The file generation unit 35 generates an execution file for setting the wireless terminal 4 based on the user information setting file 1. The file generation unit 35 may generate a client certificate and a server certificate in addition to the execution file for setting the wireless terminal 4 when the authentication system column 14 is “EAP-TLS” based on the user information setting file 1. In this example, the execution file is an execution program for setting an SSID and a password in the wireless terminal 4. The password is set in the wireless terminal 4 when the authentication system is WPA-PSK.

The second transmission unit 37 transmits the execution file generated by the file generation unit 35 or information about the execution file to the wireless terminal 4. The second transmission unit 37 may transmit the server certificate and the client certificate generated by the file generation unit 35 to the wireless terminal 4. The data are transmitted to the wireless terminal 4 via a network other than the wireless network to which the wireless terminal 4 can connect. A mail address at a transmission destination is a mail address inputted to the mail address column 12 in the user information setting file 1. The information about the execution file is not a setting execution program itself of an electronic certificate for the wireless terminal 4 to connect to the wireless network for authentication but a URL (uniform resource locator) or a link capable of downloading the program and the certificate. The second transmission unit 37 also transmits data via the communication unit 80, like the first transmission unit 36.

The authentication unit 38 performs a user authentication for the wireless terminal 4 to connect to a wireless network. If an EAP is used as an authentication system, the authentication unit 38 has a function of the RADIUS server. In the case of an EAP respectively using a user name and a password as authentication keys, for example, when the wireless terminal 4 first requires a connection permission of the wireless relay device 3, the wireless relay device 3 inquires of the authentication unit 38. The authentication unit 38 collates the user name and the password transmitted from the wireless terminal 4 with the user name and the password held in the external database to identify whether the user is a normal user. If the authentication unit 38 determines that the user is a normal user, it is notified that an authentication has been successfully performed, and the wireless terminal 4 can connect to the wireless network via the wireless relay device 3. As described above, the RADIUS server need not be contained in the wireless relay device 3. Therefore, the authentication unit 38 is not an essential component.

Although the configuration of the control unit 30 in the wireless relay device 3 has been described above, the control unit 30 in the wireless relay device 3 need not necessarily include all the above-described components. A minimum configuration of the control unit 30 in the wireless relay device 3 includes the receiving unit 31, the extraction unit 33, and the setting unit 34 surrounded by a broken line in FIG. 3. The other components can be added to the minimum configuration, as needed.

### [Operation of Wireless Relay Device]

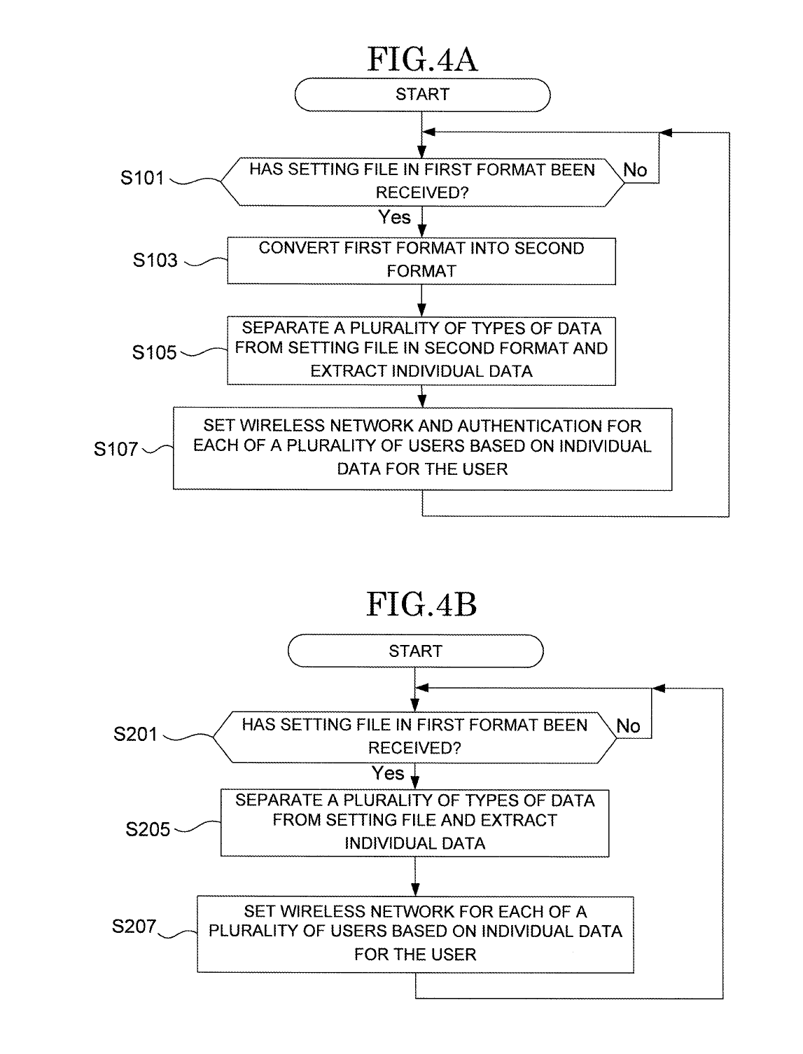

An operation of the wireless relay device 3 will be described below with reference to FIG. 4A. FIG. 4A is a flowchart illustrating an example of the operation of the wireless relay device 3 according to the first embodiment of the present invention.

First, the control unit 30 determines whether the receiving unit 31 in the wireless relay device 3 has received a setting file in a first format (step S101). Until the receiving unit 31 in the wireless relay device 3 receives the setting file in the first format, the step loops. If the setting file in the first format is less frequently received, step S101 may be omitted, to start the operation in step S103.

When the receiving unit 31 in the wireless relay device 3 receives the setting file in the first format (Yes in step S101), the conversion unit 32 in the wireless relay device 3 converts the setting file in the first format into a setting file in a second format (step S103).

Then, the extraction unit 33 in the wireless relay device 3 separates a plurality of types of data from the setting file in the second format to extract individual data for each of the plurality of users (step S105).

Then, the setting unit 34 in the wireless relay device 3 sets a wireless network and an authentication corresponding to each of the plurality of users based on the extracted individual data for the user (step S107). Accordingly, the setting of the user to be authenticated by the authentication unit 38 or the RADIUS server is completed. In this example, an example in which the setting unit 34 sets the wireless network and the authentication has been described. If a setting file does not define a setting content relating to an authentication but defines a setting content relating to a wireless network, the setting unit 34 does not set the authentication.

An example of the operation of the wireless relay device 3 has been described above. If the wireless relay device 3 has a minimum configuration, a step corresponding to step S103 is omitted, specifically as illustrated in FIG. 4B. FIG. 4B is a flowchart illustrating an example of an operation of a wireless relay device 3 according to another embodiment of the present invention. First, a control unit 30 determines whether a receiving unit 31 in the wireless relay device 3 has received a setting file in a first format (step S201). When the receiving unit 31 in the wireless relay device 3 receives the setting file in the first format (Yes in step S201), an extraction unit 33 in the wireless relay device 3 separates a plurality of types of data from the received setting file to extract individual data for each of a plurality of users (step S205). Then, a setting unit 34 in the wireless relay device 3 sets a wireless network for each of the plurality of users based on the extracted individual data for the user (step S207). In the present embodiment, an example in which the setting unit 34 sets the wireless network has been described. If the setting file defines a setting content relating to an authentication, the setting unit 34 sets not only the wireless network but also the authentication.

Assume a case where mounting of a conversion function into a second format (Configuration File) accepts only a CSV format, for example. In this case, when the first format is an XML, a step of converting the XML into the CSV format as an intermediate format and then converting the CSV format into the second format

(Configuration File) is inserted. For a user to set the wireless network and the authentication in a wireless terminal 4, an operation flow in which a file generation unit 35 in the wireless relay device 3 generates an execution file for setting a wireless terminal 4 based on a user information setting file 1 and a second transmission unit 37 transmits the execution file generated by the file generation unit 35 or information about the execution file to the wireless terminal 4 is required. This flow corresponds to step S107 and the subsequent steps.

A situation where the wireless relay device 3 sets a wireless network and an authentication for a user will be described below with reference to FIG. 5. FIG. 5 is a conceptual diagram for describing a situation where the wireless relay device 3 according to the first embodiment of the present invention sets the wireless network and the authentication for the user.

In this example, the wireless relay device 3 does not contain the authentication unit 38, and a RADIUS server 5 is provided outside the wireless relay device 3. A database 6 is not a local data base in the RADIUS server 5 but an external database.

When the user information setting file 1 is applied from the manager terminal 2, and the wireless relay device 3 in an initial state is caused to accept the user information setting file 1, as illustrated in FIG. 1, the wireless relay device 3 automatically sets a wireless network and an authentication for each of the plurality of users based on the user information setting file 1. If “EAP-TLS” using an electronic certificate for an authentication on the side of the RADIUS server 5 is inputted in the authentication system column 14 in the user information setting file 1, the wireless relay device 3 automatically generates an electronic certificate (client certificate) 7.

In an example illustrated in FIG. 5, when an SSID is “Guest”, an authentication system is “WPA-PSK”. However, the present invention is not limited to this. The authentication system may be WPA2-PSK. When the SSID is “Sales”, the authentication system is “EAP-TLS”. However, the present invention is not limited to this. The authentication system may be another EAP system.

Transmission of data by the wireless relay device 3 to other wireless relay devices will be described below with reference to FIG. 6. FIG. 6 is a conceptual diagram illustrating that wireless relay device 3 according to the first embodiment of the present invention transmits data to the other wireless relay devices.

A first transmission unit 36 in a wireless relay device (a controller AP) 3a transmits extracted individual data for each of the plurality of users to the other wireless relay devices 3b, 3c, 3n, etc. to be linked with the wireless relay device 3a. The other wireless relay devices 3b, 3c, . . . , 3n to be linked with the wireless relay device 3a may be each referred to as a member access point. Examples of the individual data for each of the plurality of users include a mail address, an SSID, information about an authentication system, a MAC address, and time zone information illustrated in FIG. 1. In this example, the first transmission unit 36 in the wireless relay device (controller AP) 3a transmits the individual data for each of the plurality of users to all the member access points.

The wireless relay device 3a may select the member access point for each of the users and transmit the individual data for the user to the selected member access point. In this case, the member access point is not a VAP but an access point having one SSID.

In the present embodiment, the setting file in the first format defines a setting content of the wireless relay device using a plurality of types of data for each of the plurality of users. The plurality of types of data include at least identification information of a wireless terminal and information about an authentication system. A wireless network and an authentication for each of the plurality of users are set based on the individual data for the user extracted from the setting file. In the present embodiment, an effect of enabling many elements to be thus collectively set for the plurality of users is produced. An effect of enabling an SSID, an authentication system, a MAC address filter, and the like to be collectively changed in not only a case where initial setting is performed but also a case where the setting is changed is also produced. As a result, an SSID, which is no longer required, can be timely deleted. A PSK can also be timely changed. An account, which is no longer required, can be deleted. Further, information (a MAC address) about a wireless terminal, which is no longer required, can be deleted. Therefore, an effect of enabling appropriate access control to be performed without connecting the unnecessary wireless terminal to the wireless relay device 3 is produced.

If the setting file in the first format is described in a natural language, the conversion unit 32 in the wireless relay device 3 converts the first format into a Configuration File (environment setting file) as a second format. Therefore, an effect of enabling a manager to simply perform input to the setting file in the first format is produced.

In the present embodiment, the first transmission unit 36 in the wireless relay device (controller AP) 3 transmits the extracted individual data for each of the plurality of users to the other wireless relay devices (member access points) to be linked with the wireless relay device 3a. Therefore, an effect of enabling the wireless network and the authentication for each of the plurality of users to be also set for the member access point based on the individual data for the user is produced.

In the present embodiment, the file generation unit 35 in the wireless relay device 3 generates an execution file for setting the wireless terminal 4 based on the user information setting file 1, and the second transmission unit 37 transmits the execution file or information about the execution file to the wireless terminal 4. Such an effect that setting for the wireless terminal 4 to connect to the wireless network for authentication is completed when the transmitted execution file is executed at the wireless terminal 4 is produced. Particularly in the case of EAP-TLS using an electronic certificate as an authentication system, an execution file is an electronic certificate setting execution program for the wireless terminal 4 to connect to the wireless network for authentication, and the electronic certificate is a route certificate for verifying a server certificate presented by the authentication unit 38 at the time of connection on the side of the wireless terminal 4. An effect of enabling more secure connection when the setting of the route certificate is completed on the side of the wireless terminal 4 is produced.

In the present embodiment, an effect of enabling a time zone in which the wireless terminal can connect to the wireless network to be set, as needed, for each

SSID and enabling access control based on a user attribute to be performed when the setting file includes information about the time zone in which the wireless terminal can connect to the wireless network is produced.

### Second Embodiment

In the first embodiment, description has been made, assuming that the communication relay device is the wireless access point (wireless relay device) and the communication terminal is the terminal using wireless communication (wireless terminal). However, the communication relay device may be a device which relays wired communication, and the communication terminal may be a terminal using wired communication.

If the communication relay device is the wired communication relay device, and the communication terminal is the terminal using wired communication, a user information setting file does not include an SSID column 13 but includes an identification column for the wired communication relay device, unlike in the first embodiment.

In the present embodiment, similar effects to the effects in the first embodiment are produced.

### (Modification 1)

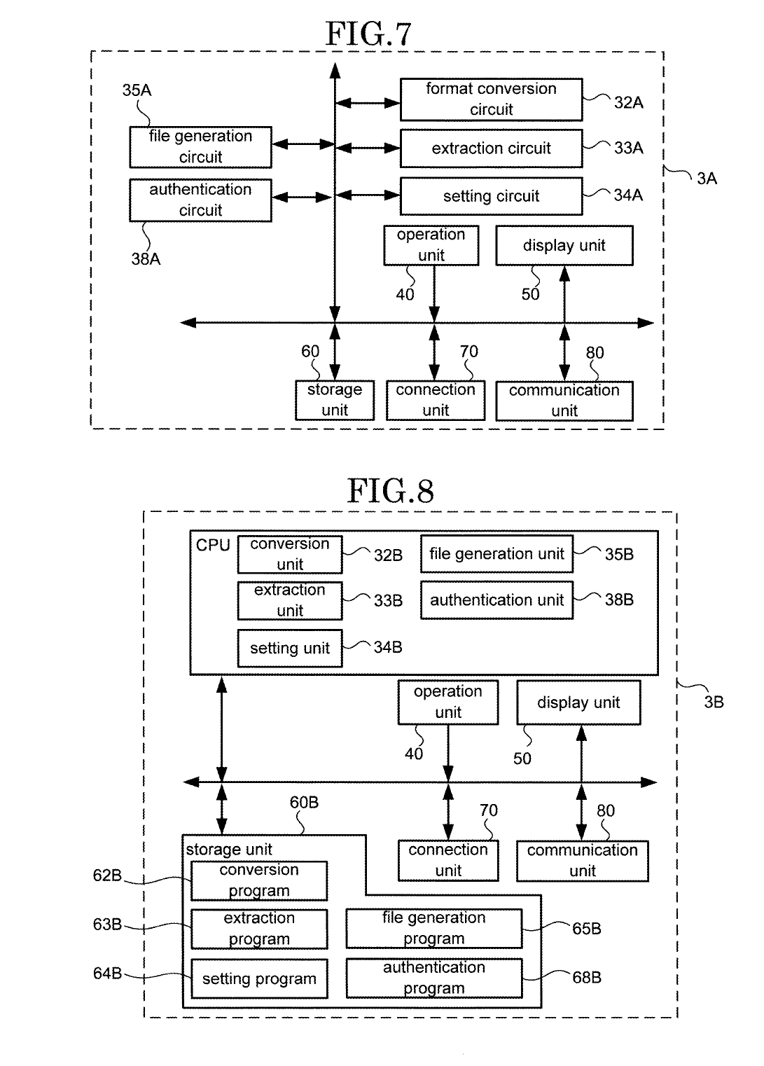

The respective communication relay devices in the above-described embodiments can be each implemented by a hardware configuration, as described below, or a hardware configuration such as a circuit using an FPGA (Field Programmable Gate Array). Although an example of a wireless relay device 3 is illustrated below, the same applies to a wired relay device. FIG. 7 is a block diagram illustrating a configuration of a wireless relay device 3A according to a modification to the present invention. Description of components which overlap the components in the wireless relay device 3 is omitted. As illustrated in FIG. 7, the wireless relay device 3A includes a format conversion circuit 32A, an extraction circuit 33A, a setting circuit 34A, a file generation circuit 35A, and an authentication circuit 38A. The control unit 30 in the wireless relay device 3 is implemented by the format conversion circuit 32A, the extraction circuit 33A, the setting circuit 34A, the file generation circuit 35A, and the authentication circuit 38A. The format conversion circuit 32A corresponds to the conversion unit 32 in the wireless relay device 3, the extraction circuit 33A corresponds to the extraction circuit 33 in the wireless relay device 3, the setting circuit 34A corresponds to the setting unit 34 in the wireless relay device 3, the file generation circuit 35A corresponds to the file generation unit 35 in the wireless relay device 3, and the authentication circuit 38A corresponds to the authentication unit 38 in the wireless relay device 3. In the modification, similar effects to the effects in each of the above-described embodiments are also produced.

### (Modification 2)

The respective communication relay devices in the above-described embodiments can also be each implemented by a software configuration, as described below. Although an example of the wireless relay device 3 is illustrated below, the same applies to a wired relay device. FIG. 8 is a block diagram illustrating a configuration of a wireless relay device according to another modification to the present invention. As illustrated in FIG. 8, a storage unit 60B stores a conversion program 62B, an extraction program 63B, a setting program 64B, a file generation program 65B, and an authentication program 68B. A conversion unit 32B in a CPU executes the conversion program 62B stored in the storage unit 60B to convert a setting file in a first format into a setting file in a second format. The conversion unit 32B corresponds to the conversion unit 32 in the wireless relay device 3. Similarly, an extraction unit 33B corresponds to the extraction unit 33 in the wireless relay device 3, a setting unit 34B corresponds to the setting unit 34 in the wireless relay device 3, a file generation unit 35B corresponds to the file generation unit 35 in the wireless relay device 3, and an authentication unit 38B corresponds to the authentication unit 38 in the wireless relay device 3. In the modification, similar effects to the effects in each of the above-described embodiments are also produced.

The present invention is not limited to the above-described embodiments, and can be appropriately changed without departing from the scope and spirit of the invention.

What is claimed is:

1. A wireless relay device comprising a processor configured to execute instructions of:
receiving a setting file in a first format for defining a setting content relating to a wireless network, the setting file defining a plurality of types of data including identification information of a wireless terminal to correspond to each of a plurality of users;
separating the plurality of types of data from the setting file to extract individual data for each of the plurality of users; and
setting a wireless network for each of the plurality of users based on the individual data for the user.

2. The wireless relay device according to claim 1, wherein
the setting file further defines a setting content relating to an authentication,
the plurality of types of data further include information about an authentication system, and
the setting the wireless network includes setting an authentication for each of the plurality of users based on the individual data for the user.

3. The wireless relay device according to claim 1, wherein
the processor is further configured to execute instructions of converting the setting file in the first format into a setting file in a second format, and
the extracting the individual data includes separating a plurality of types of data from the setting file in the second format and extracting individual data for each of the plurality of users.

4. The wireless relay device according to claim 1, wherein
the processor is further configured to execute instructions of transmitting the individual data for each of the plurality of users to other wireless relay devices to be linked with the wireless relay device.

5. The wireless relay device according to claim 1, wherein
the processor is further configured to execute instructions of:
generating an execution file for setting the wireless terminal based on the setting file; and
transmitting the execution file or information about the execution file to the wireless terminal.

6. The wireless relay device according to claim 2, wherein
the processor is further configured to execute instructions of:
performing an authentication for the wireless terminal to connect to the wireless network; and
transmitting information indicating that the authentication has been successfully performed to the wireless terminal when receiving from the wireless terminal the information about the authentication system corresponding to the wireless terminal.

7. The wireless relay device according to claim 1, wherein
the setting file includes information about a time zone in which the wireless terminal can connect to the wireless network.

8. The wireless relay device according to claim 2, wherein
the setting the wireless network includes providing information including the identification information of the wireless terminal for the wireless terminal to connect to the wireless network via the wireless relay device, and
the setting the authentication includes providing an authentication system required of the wireless terminal for the wireless terminal to connect to the wireless network via the wireless relay device.

9. The wireless relay device according to claim 1, wherein
the information about the authentication system includes information about at least one of EAP-TLS, EAP-TTLS, EAP-PEAP, EAP-FAST, EAP-MD5, WPA-PSK, and WPA2-PSK.

10. The wireless relay device according to claim 1, wherein
the identification information of the wireless terminal includes a MAC address, and
identification information of the wireless relay device includes an ESSID.

11. A setting method performed by a wireless relay device, comprising:
receiving a setting file in a first format for defining a setting content relating to a wireless network, the setting file defining a plurality of types of data including identification information of a wireless terminal to correspond to each of a plurality of users;
separating the plurality of types of data from the setting file to extract individual data for each of the plurality of users; and
setting a wireless network for each of the plurality of users based on the individual data for the user.

12. The setting method according to claim 11, wherein
the setting file further defines a setting content relating to an authentication,
the plurality of types of data further include information about an authentication system, and
the setting the wireless network includes setting an authentication for each of the plurality of users based on the individual data for the user.

13. The setting method according to claim 11, further comprising:
converting the setting file in the first format into a setting file in a second format; and
the extracting the individual data includes separating a plurality of types of data from the setting file in the second format and extracting individual data for each of the plurality of users.

14. The setting method according to claim 11, further comprising
transmitting the extracted individual data for each of the plurality of users to other wireless relay devices to be linked with the wireless relay device.

15. The setting method according to claim 11, further comprising:
generating an execution file for setting the wireless terminal based on the setting file; and
transmitting the generated execution file or information about the execution file to the wireless terminal.

16. The setting method according to claim 12, further comprising:
performing an authentication for the wireless terminal to connect to the wireless network; and
transmitting information indicating that the authentication has been successfully performed to the wireless terminal when receiving from the wireless terminal the information about the authentication system corresponding to the wireless terminal.

17. The setting method according to claim 11, wherein
the setting file includes information about a time zone in which the wireless terminal can connect to the wireless network.

18. The setting method according to claim 12, wherein
the setting the wireless network includes providing information including the identification information of the wireless terminal for the wireless terminal to connect to the wireless network via the wireless relay device, and
the setting the authentication includes providing an authentication system required of the wireless terminal for the wireless terminal to connect to the wireless network via the wireless relay device.

19. The setting method according to claim 11, wherein
the information about the authentication system includes information about at least one of EAP-TLS, EAP-TTLS, EAP-PEAP, EAP-FAST, EAP-MD5, WPA-PSK, and WPA2-PSK.

20. The setting method according to claim 1, wherein
the identification information of the wireless terminal includes a MAC address, and
identification information of the wireless relay device includes an ESSID.
